(19) United States
(12) Patent Application Publication
(10) Pub. No.: US 2020/0299077 A1
(43) Pub. Date: Sep. 24, 2020

(54) SYSTEM AND METHOD FOR ALIGNMENT OF TRAILERS TO DOCK EQUIPMENT

(71) Applicant: Siemens Logistics LLC, DFW Airport, TX (US)

(72) Inventors: Luiz Carlos Harres, Allen, TX (US); Kent Halland, The Colony, TX (US); Michael D. Carpenter, Arlington, TX (US)

(21) Appl. No.: 16/821,019

(22) Filed: Mar. 17, 2020

Related U.S. Application Data
(60) Provisional application No. 62/819,850, filed on Mar. 18, 2019.

(51) Int. Cl. B65G 67/24

(52) U.S. Cl. CPC B65G 67/24

(57) ABSTRACT

A system for alignment of a container or trailer to dock equipment includes a vision system for providing visual representations of a section of a container or trailer, an automated unloading apparatus for moving into an interior of the container or trailer, and a control system operably coupled to the vision system, the control system comprising a processor configured via computer executable instructions to receive the visual representations of the section of the container or trailer, interpret the visual representations of the section of the container or trailer, and output control commands for alignment of the container or trailer and/or the automated unloading apparatus. Further, a method for aligning a trailer or container to dock equipment is provided.

### CROSS-REFERENCE TO RELATED APPLICATIONS

This application claims the benefit of U.S. provisional patent application No. 62/819,850 filed Mar. 18, 2019, in the U.S. Patent and Trademark Office, the contents of which are herein incorporated by reference in their entirety.

### BACKGROUND

### 1. Field

Aspects of the present disclosure generally relate to the technical field of mail and parcel processing techniques.

### 2. Description of the Related Art

Automatic unloading of parcels or articles from a container or trailer may be accomplished using an automated unloading apparatus. A known automatic unloading apparatus for use with a container or trailer includes for example a ramp and a conveyor. Multiple parcels are located on a base belt within the container or trailer, wherein the unloading apparatus is configured to move into an interior of the container or trailer for removing the multiple parcels. The unloading apparatus requires that the trailer is in alignment with dock equipment whenever the unloading apparatus enters or exits the trailer. However, the process of aligning the trailer and dock equipment for operations is manual and prone to human error.

### SUMMARY

A first aspect of the present disclosure provides a system for alignment of a container or trailer to dock equipment comprising a vision system configured to provide visual representations of a section of a container or trailer, an automated unloading apparatus configured to move into an interior of the container or trailer, and a control system operably coupled to the vision system, the control system comprising at least one processor configured via computer executable instructions to receive the visual representations of the section of the container or trailer, interpret the visual representations of the section of the container or trailer, and output control commands for alignment of the container or trailer and the automated unloading apparatus.

A second aspect of the present disclosure provides a method for aligning a trailer or container to dock equipment comprising providing visual representations of a section of a container or trailer by a vision system, receiving and interpreting the visual representations of the section of the container or trailer by a control system, and aligning the container or trailer to dock equipment based on the visual representations.

### BRIEF DESCRIPTION OF THE DRAWINGS

FIG. 1 depicts a schematic view of an automated unloading apparatus in accordance with an exemplary embodiment of the present disclosure.

FIG. 2 depicts a schematic view of a system for alignment of trailers to dock equipment in accordance with an exemplary embodiment of the present disclosure.

FIG. 3 depicts a flow chart of a method for aligning trailers to dock equipment in accordance with an exemplary embodiment of the present disclosure.

### DETAILED DESCRIPTION

To facilitate an understanding of embodiments, principles, and features of the present disclosure, they are explained hereinafter with reference to implementation in illustrative embodiments. In particular, they are described in the context of being a system and method for aligning trailers or containers and dock equipment. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

Various disclosed embodiments include unloading items, such as for example parcels or packages, from a trailer or other container generally without operator intervention. An automated unloading apparatus is provided, wherein a nose ramp of the automated unloading apparatus is moved under a base belt in the trailer and under a first item of a plurality of items in the trailer. As the ramp continues advancing, the item is moved onto a conveyor, which is adapted to carry the item out of the trailer. In embodiments, a stack control curtain maintains the remaining items in a stack or pile during and after removal of the first item, and/or a tensioning mechanism maintains a desired tension on the base belt as the ramp moves under the base belt and the first item.

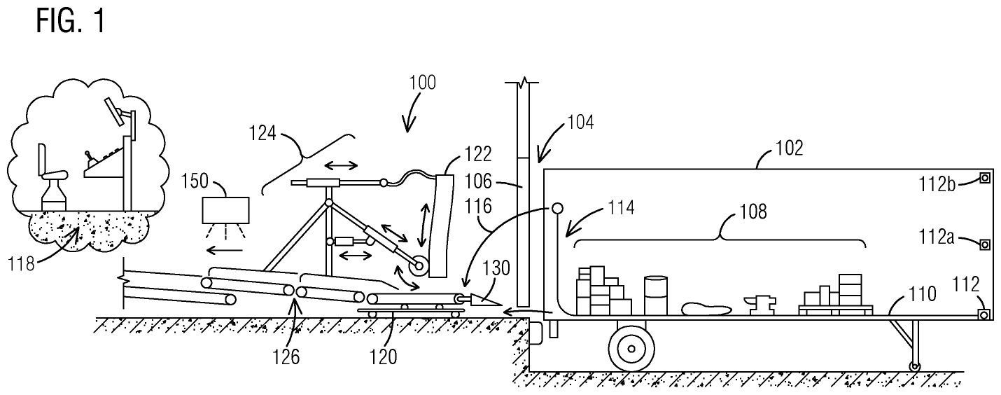

FIG. 1 depicts a schematic view of an unloading apparatus 100, herein also simply referred to as unloader 100, in accordance with an exemplary embodiment of the present disclosure.

A trailer 102 is positioned adjacent to a loading dock 104 and a dock door area 106 for unloading. In the trailer 102 are loaded items 108, which are to be unloaded by the unloader 100. The items 108 are positioned on top of a base belt 110, a first end of which is attached to the trailer at an attachment point 112. A second end of the base belt 110 (opposite to the first end) may be raised to a first transit position 114 to provide supported to stacked items during transit to help prevent stack collapse. The second end of the base belt 110 may alternately be placed in a second transit position (not shown in FIG. 1) on the floor of the trailer 102, where the base belt 110 may be rolled or gathered during transit. From either the first or second transit position, to initiate unloading of the trailer 102, the second end of the base belt 110 is brought generally along the path indicated by the arrow 116 to be attached to the unloader 100, as described in greater detail below.

The unloader 100 is positioned at the open door of the trailer 102 by an operator at an operator console 118, also referred to as operator kiosk or station. The operator may use for example a video camera (not shown in FIG. 1) that is mounted to the unloader 100 or to the loading dock 104 and presents the operator with a view of the unloader 100 and the trailer 102.

The unloader 100 includes a positioning mechanism 120, which is remotely operated by the operator to position the unloader 100 at the entrance to the trailer 102. The positioning mechanism 120 may be a motorized caster or other mechanism suitable for positioning the unloader 100 relative to the trailer 102 prior to initiating an unloading process or during the unloading process. The positioning mechanism 120 is operable to position the unloader 100 at least along a longitudinal axis of the trailer 102 or horizontally relative to the trailer 102. In some embodiments, the unloader 100 is substantially a same width as the interior of the trailer 102, such that the unloader 100 substantially fills the trailer 102 from one sidewall to the other sidewall.

The unloader 100 moves into the trailer 102 along the trailer floor, sliding nose ramp 130 under the base belt 110 and under a rearmost item of the items 108. By sliding the nose ramp 130 under an item 108 while the item 108 remains on the base belt 110, the unloader 100 reduces the possibility of the nose ramp 130 pushing the items 108 into the trailer 102, rather than sliding it up onto conveyor 126. When moving forward, the unloader 100 moves at a speed that substantially matches a speed of a transport belt of the conveyor 126. In this way, the items 108 are transferred with substantially no relative motion from the base belt 110 to the conveyor 126. The unloader 100 may also include a stack control curtain 122 mounted to a positioning mechanism 124. The unloader 100 is coupled to an extendible conveyor 126, which is operable to carry items unloaded by the unloader 100 from the trailer 102. A sensor 150 may be mounted in a position that enables the sensor 150 to sense items on the unloader 100 or the extendible conveyor 126. The sensor 150 is operable to sense a label, RFID tag, barcode, or other identifying feature of such items.

Further embodiments of the unloader apparatus 100 are described for example in U.S. Pat. No. 8,651,794 B2 to Pippin and U.S. Pat. No. 9,738,466 B2 to Pippin which are incorporated by reference herein in their entirety.

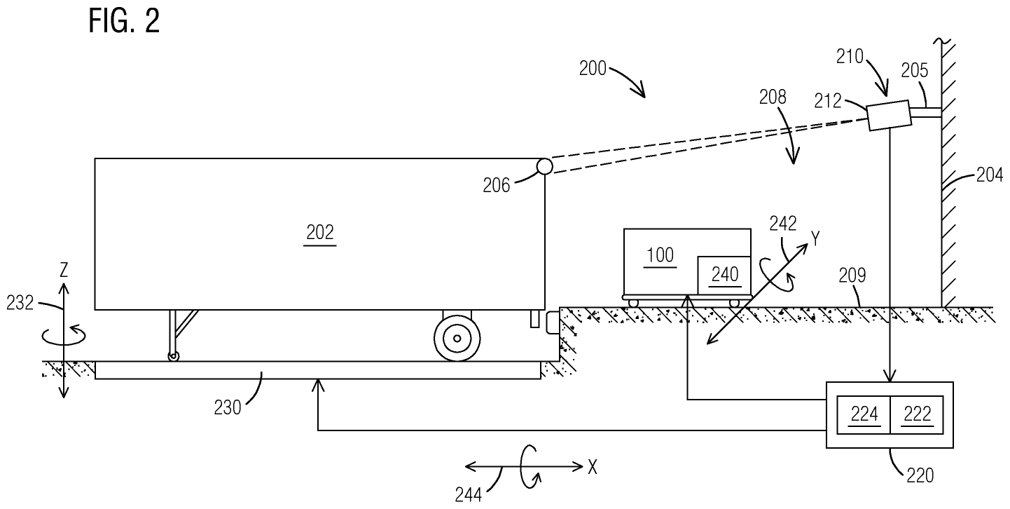

FIG. 2 depicts a schematic view of a system 200 for alignment of trailers to dock equipment in accordance with an exemplary embodiment of the present disclosure. For an unloading operation as described for example with reference to FIG. 1, it is necessary that trailer or container 202 is in alignment with dock equipment, such as unloader 100, of dock facility 208 whenever the unloader 100 enters or exits the trailer 202. Further, the trailer 202 becomes lighter as the unloader 100 unloads the parcels and items (see items 108 in FIG. 1) from an interior of the trailer 202 and causes the trailer 202 to rise in respect to the dock equipment, e.g. unloader 100. When the unloader 100 tries to exit the trailer 202, the previously set alignment needs correction. Currently, such an alignment is a manual process which is prone to human error. Thus, an improved alignment system 200 and method 300 are described which provide an automated alignment and/or alignment correction of the container 202 and unloader 100.

In an exemplary embodiment, a system 200 for alignment of a container or trailer 202 to dock equipment comprises a vision system 210 configured to provide visual representations, of a section of a container or trailer 202. The vision system 210 can be a monochrome vision system and can comprise for example one or more camera(s), such as one or more monochromatic camera(s) 212 providing images and/or video. In another embodiment, the vision can comprise one or more laser scanner(s) providing for example laser scanner images. Further, it should be noted that the vision system 210 can comprise many different imaging, scanning or monitoring systems as long as there are capable of providing images, video or visual representations of at least a section of the container or trailer 202, such as for example LiDAR (Light Detection and Ranging) systems.

For example, the vision system 210 can be firmly mounted to the dock facility 208, for example to a wall 204 of the dock facility 208, using for example a mounting bracket 205, and is pointed towards a specific section of the container or trailer 202. However, the vision system 210 may be positioned or arranged at other locations, such as for example the automated unloading apparatus 100 or alignment equipment or at a place suitable for the vision system 210 to perform the described functions. During operation, the vision system 210 looks at and monitors the specific section, which is for example an upper rear section 206 of the container or trailer 202. The section 206 is selected to minimize interference from movement or other objects below the section 206, such as for example (human) operators and/or the unloader 100.

The vision system 210 provides visual representations, such as images or video, of the section 206 of the container or trailer 202. A control system 220 is operably coupled to the vision system 210. The control system 210 comprises at least one processor 222 and is configured via computer executable instructions to receive and interpret the visual representations of the section 206 of the container or trailer 202. This means that the control system 220 comprises software to interpret the visual representations provided by the vision system 210.

The control system 220 is further configured to output control commands for alignment, for example to alignment equipment of the container or trailer 202 and/or dock equipment, such as the unloader 100. For example, the at least one processor 222 can be configured to output the control commands. In another example, the control system 220 comprises a programmable logic controller (PLC) 224 that is programmed to receive input of the vision system 210 and to output control commands, e.g. to control alignment equipment. The PLC 224 can be part of the control system 220 or can be separately arranged within the system 220.

The vision system 210 may be coupled via cables, i.e. wired, to the control system 220. In other instances, the vision system 210 and the control system 220 may be coupled wirelessly, utilizing for example the Internet or other wireless communications networks.

A first alignment device 230 is assigned to the container or trailer 202, such as for example a lift arranged to align the container or trailer 202 vertically along a vertical axis (z), see arrow 232. The first alignment device 230 can be part of the container or trailer 202 or can be separate from the container or trailer 202, for example a lift below the trailer 202 as illustrated in FIG. 2.

A second alignment device 240 is assigned to the unloader 100. The alignment device 240 of the unloader 100 can be referred to as dock aligner and is used to align the unloader 100 at least along a longitudinal lateral axis (y) of the trailer 202 (horizontally relative to the trailer 202), see arrow 242. The second alignment device 240 may also be referred to as positioning mechanism 120, for example as described previously with reference to FIG. 1. The second alignment device 240 or positioning mechanism 120 may be a motorized caster or other mechanism suitable for positioning the unloader 100 relative to the trailer 202 prior to initiating an unloading process or during the unloading process. The second alignment device 240 may be part of the unloader 100 or can be separate from the unloader 100.

In another embodiment, the alignment system 200 is configured such that the trailer/container 202 and dock equipment (unloader 100) can be aligned along multiple axes, such as vertical (z) and lateral (y) as described before, and along a longitudinal axis (x), see arrow 244. Alignment along longitudinal axis (x) is used to ensure that the container or trailer 202 is close enough to the dock 209, wherein the container/trailer 202 or the unloader 100 can be easily moved along axis (x) to provide proper alignment in this direction (x).

In another embodiment, the alignment system 200 can be configured such that the trailer/container 202 and dock equipment (unloader 100) can be aligned with respect to angles in terms of rotation about the axes x, y, z. Specifically, in addition to alignment along the axes x, y, z, angular alignment is also provided. Angular alignment refers to angles of rotation about the axes x, y, z. Rotation about the x-axis is referred to as rolling or tilting, rotation about the y-axis is referred to as pitching and rotation about the z-axis is referred to as yawing. The container/trailer 202 and/or unloader 100 are configured such that they can be aligned according to a tilt angle, a pitch angle or a yaw angle. In this case, the alignment equipment of the container/trailer 202 and/or the unloader 100 is/are configured to perform alignment according to tilt, pitch and yaw angle(s). This means that the alignment system 200 can provide alignment in 6 (six) directions (along axes x, y, z and tilt, pitch and yaw). Alignment can be performed by the container/trailer 202 alone, the unloader 100 alone or a combination of the container/trailer 202 and the unloader 100. Further, it should be noted that the alignment devices 230, 240 are only shown schematically in FIG. 2.

The control system 220, for example PLC 224, is configured to output control commands to the first alignment device 230 (assigned to container or trailer 202) and/or second alignment device 240 (assigned to unloader 100) in order to change a vertical and/or horizontal position of the trailer 202 and/or the unloader 100. Further, the control system 220 is configured to detect deviations or differences in multiple images or visual representations of the specific section, e.g. section 206, of the trailer 202.

When the vision system 210 comprise one or more camera(s) 212, the vision system 210 provides a change in pixel position, regardless of what the vision system 210 sees. The system 200, e.g. control system 220, only needs to consider coordinated movement of most (majority of) pixels of the section 206 as representing actual movement. This acts as a filter for things that may momentarily move in a field of view of the vision system 210 (e.g. flying debris, human arms etc.). When the vision system 210 comprises for example one or more laser scanners, the one or more laser scanners create a point cloud (that act as pixels) and can provide a change in the point cloud. A point cloud as used herein is a set of data points produced by the laser scanner(s).

For example, the vision system 220 provides a first image and a second image of the section 206 of the trailer 202, wherein the first image is different from the second image, for example comprises different pixel positions or comprises different point clouds. The control system 220 is adapted to recognize the difference and is programmed to restore or recover the first image by aligning the trailer 202 to a position corresponding to the first image of the trailer 202. Thus, the control system 220 will output corresponding control commands or signals to the alignment equipment 230, 240 to align the trailer 202 and/or unloader 100 to the position corresponding to the first image. Alignment may be performed periodically or continuously. For example, alignment may be performed when differences along any of the axis x, y, z and angles roll, tilt, yaw are outside predefined thresholds.

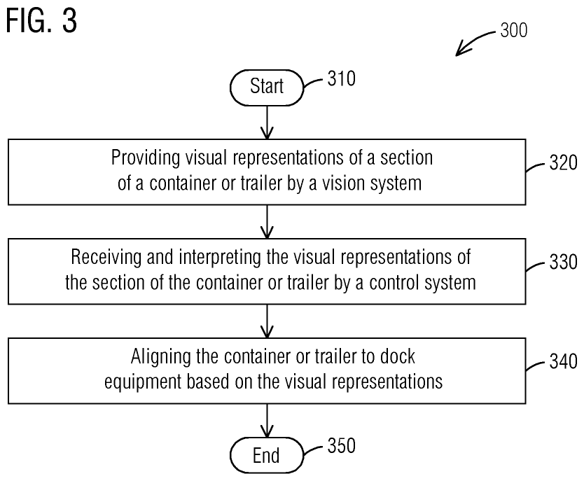

FIG. 3 depicts a flow chart of a method 300 for aligning trailers to dock equipment in accordance with an exemplary embodiment of the present disclosure. The process or method 300 can be implemented by using any of the features, components, or devices discussed herein, or any combination of them. The method 300 is performed, for example, by a system 200 as disclosed herein, and under the control of its control system 220.

While the method 300 is described as a series of acts that are performed in a sequence, it is to be understood that the method 300 may not be limited by the order of the sequence. For instance, unless stated otherwise, some acts may occur in a different order than what is described herein. In addition, in some cases, an act may occur concurrently with another act. Furthermore, in some instances, not all acts may be required to implement a methodology described herein.

The method 300 may start at 310 and may include an act 320 of providing visual representations of a section 206 of a container or trailer 202 by a vision system 210. The method 300 may also include act 330 of receiving and interpreting the visual representations of the section 206 of the container or trailer 202 by a control system 220, and an act 340 of aligning the container or trailer 202 to dock equipment based on the visual representations. At 350, the method 300 may end. It should be appreciated that the described method 300 may include additional acts and/or alternative acts corresponding to features described with respect to the alignment system 200.

In an embodiment, the method 300 further comprises detecting a deviation (difference) between a first visual representation and a second visual representation of a section 206 of the trailer or container 202, wherein the aligning is based on the deviation between the first and second visual representations.

In another embodiment, the method 300 further comprises initially aligning the container or trailer 202 to the dock equipment according to a first position of the section 206 of the container or trailer 202, providing a first visual representation of the section in the first position, providing a second visual representation of the section 206 in a second position, determining a difference between the first and second visual representations of the section 206, and aligning the container or trailer 202 to the first visual representation and first position of the section 206.

In an embodiment, the method 300 in combination with the system 200 can be configured as semi-automatic solution. In another embodiment, the method 300 and system 200 can be configured as fully automatic solution.

With respect to a semi-automatic solution, the step of initially aligning the container or trailer 202 to the dock equipment is performed for example by interfacing with a human operator. An operator initially aligns the trailer 202 to the dock equipment, remotely operating the alignment device 230, 240 and using the control system 220. The operator sets an initial optimal alignment which is monitored by the vision system 210 and stored by the control system 220 as “optimal” or “ideal” position of the trailer 202 and dock equipment, e.g. unloader 100. The initial alignment provides a visual representation or image of the section 206 the vision system 210 sees as ideal. Any variation is feedback for the alignment devices 230, 240 (lift or dock aligner of unloader 100) for automatic recovery of the ideal position initially stored. The semi-automatic solution requires an operator to initially set correct alignment. The initial setting is the reference that the vision system 210 attempts to keep steady. After initial alignment, the system 200 and method 300 perform alignment without interaction of the operator.

In another embodiment, the initial alignment is performed fully automated thereby providing a fully automated solution of alignment. For a fully automated solution, one or more reference marks, such as for example a sticker or paint, is/are added to a section of the trailer or container 202. The reference mark(s) should not be added to doors of the trailer or container 202, but for example to a section above the doors. The vision system 210 monitors the reference mark(s) located for example at section 206 and provides images or video of the reference mark(s). A reference mark is located a known distance vertically from dock 209 of the dock facility 208, and a known distance horizontally from the center of the trailer 202. This information is provided to the system 200, specifically control system 220, and the control system 220 uses this information in order to align the trailer or container 202. The initial alignment as well as alignment performed during an unloading process is performed by the system 200 without interaction of an operator.

It should be appreciated that acts associated with the above-described methodologies, features, and functions (other than any described manual acts) may be carried out by one or more data processing systems, such as for example control system 220 via operation of at least one processor 222, 224. As used herein, a processor corresponds to any electronic device that is configured via hardware circuits, software, and/or firmware to process data. For example, processors described herein may correspond to one or more (or a combination) of a microprocessor, central processing unit (CPU) or any other integrated circuit (IC) or other type of circuit that is capable of processing data in a data processing system. As discussed previously, the processor 330 that is described or claimed as being configured to carry out a particular described/claimed process or function may correspond to a CPU that executes computer/processor executable instructions stored in a memory in form of software and/or firmware to carry out such a described/claimed process or function. However, it should also be appreciated that such a processor may correspond to an IC that is hard wired with processing circuitry (e.g., an FPGA or ASIC IC) to carry out such a described/claimed process or function.

In addition, it should also be understood that a processor that is described or claimed as being configured to carry out a particular described/claimed process or function may correspond to the combination of the processor with the executable instructions (e.g., software/firmware apps) loaded/installed into a memory (volatile and/or non-volatile), which are currently being executed and/or are available to be executed by the processor to cause the processor to carry out the described/claimed process or function. Thus, a processor that is powered off or is executing other software, but has the described software installed on a data store in operative connection therewith (such as on a hard drive or SSD) in a manner that is setup to be executed by the processor (when started by a user, hardware and/or other software), may also correspond to the described/claimed processor that is configured to carry out the particular processes and functions described/claimed herein.

In addition, it should be understood, that reference to “a processor” may include multiple physical processors or cores that are configures to carry out the functions described herein. Further, it should be appreciated that a data processing system may also be referred to as a controller that is operative to control at least one operation.

It is also important to note that while the disclosure includes a description in the context of a fully functional system and/or a series of acts, those skilled in the art will appreciate that at least portions of the mechanism of the present disclosure and/or described acts are capable of being distributed in the form of computer/processor executable instructions (e.g., software and/or firmware instructions) contained within a data store that corresponds to a non-transitory machine-usable, computer-usable, or computer-readable medium in any of a variety of forms. The computer/processor executable instructions may include a routine, a sub-routine, programs, applications, modules, libraries, and/or the like. Further, it should be appreciated that computer/processor executable instructions may correspond to and/or may be generated from source code, byte code, runtime code, machine code, assembly language, Java, JavaScript, Python, Julia, C, C #, C++ or any other form of code that can be programmed/configured to cause at least one processor to carry out the acts and features described herein. Still further, results of the described/claimed processes or functions may be stored in a computer-readable medium, displayed on a display device, and/or the like.

What is claimed is:

1. A system for alignment of a container or trailer to dock equipment comprising:
a vision system configured to provide visual representations of a section of a container or trailer,
an automated unloading apparatus configured to move into an interior of the container or trailer, and
a control system operably coupled to the vision system, the control system comprising at least one processor configured via computer executable instructions to
receive the visual representations of the section of the container or trailer,
interpret the visual representations of the section of the container or trailer, and
output control commands for alignment of the container or trailer and the automated unloading apparatus.

2. The system of claim 1, wherein the control system is configured to detect a deviation between a first visual representation and a second visual representation of the section, and to output the control commands for alignment based on the deviation between the first and second visual representations.

3. The system of claim 1, wherein the container or trailer comprises a first alignment device, and the control system is configured to output control commands to the first alignment device.

4. The system of claim 1, wherein the automated unloading apparatus comprises a second alignment device, and the control system is configured to output control commands to the second alignment device.

5. The system of claim 3, wherein the first and/or second alignment devices are configured to perform alignment along multiple axes including longitudinal axis, vertical axis and lateral axis.

6. The system of claim 5, wherein the first and/or second alignment devices are configured to perform alignment according to tilt, pitch or yaw corresponding to rotation about the longitudinal axis, vertical axis and lateral axis.

7. The system of claim 1, wherein for an alignment process the control system is configured to output control commands to the first alignment device, or the second alignment device, or a combination of the first and second alignment devices.

8. The system of claim 1, wherein the control system comprises a programmable logic controller (PLC).

9. The system of claim 1, wherein the vision system provides the visual representations of an upper rear section of the container or trailer.

10. The system of claim 1, further comprising one or more reference marks located at a predefined position of the container or trailer, wherein the vision system is configured to provide visual representations of the one or more reference marks.

11. A method for aligning a trailer or container to dock equipment comprising:
providing visual representations of a section of a container or trailer by a vision system,
receiving and interpreting the visual representations of the section of the container or trailer by a control system, and
aligning the container or trailer to dock equipment based on the visual representations.

12. The method of claim 11, further comprising:
detecting a deviation between a first visual representation and a second visual representation of a section of the trailer or container, wherein the aligning is based on the deviation between the first and second visual representations.

13. The method of claim 11, further comprising:
initially aligning the container or trailer to the dock equipment according to a first position of the section of the container or trailer,
providing a first visual representation of the section of the container or trailer in the first position,
providing a second visual representation of the section of the container or trailer in a second position,
determining a difference between the first and second visual representations of the section, and
aligning the container or trailer to the first visual representation and first position of the section.

14. The method of claim 13, wherein an initial alignment of the container or trailer is performed manually.

15. The method of claim 13, wherein the method including the initial alignment is performed fully automated.

16. The method of claim 15, further comprising adding a reference mark to the container or trailer, wherein the visual representations include representations of the reference mark.

17. The method of claim 11, wherein the aligning comprises alignment along multiple axes and/or multiple angles.

18. The method of claim 15, wherein the container or trailer comprises a first alignment device, and the dock equipment comprises a second alignment device, and wherein the first and second alignment devices are configured to receive control commands for the aligning from the control system.

19. The method of claim 11, wherein the visual representations comprise representations of an upper rear section of the container or trailer.

20. The method of claim 11, wherein the vision system comprises one or more cameras or one or more laser scanners.
